(19) United States
(12) Patent Application Publication
(10) Pub. No.: US 2008/0288975 A1
(43) Pub. Date: Nov. 20, 2008

(54) Advertising system and method thereof

(76) Inventors: Albert ChuTsung Chen, Taipei City (TW); Ching Feng Wang, Tainan City (TW)

Correspondence Address: Raymond Sun, 12420 Woodhall Way, Tustin, CA, 92782, US

(21) Appl. No.: 12/152,204

(22) Filed: May 12, 2008

(30) Foreign Application Priority Data
May 14, 2007 (TW) 96117088

(51) Int. Cl. H04N 7/10

(52) U.S. Cl. 725/32

(57) ABSTRACT

An advertising system comprises an advertising server unit and a set-top box. The advertising server unit is capable of receiving at least one advertisement from at least one external advertiser, and broadcasting at least part of the advertisement to outside in a pushing manner. The set-top box is capable of receiving TV signals from outside (e.g., from TV station or satellite TV) and the advertisement, and combining the advertisement with the TV signals, and then transmitting the combined signals to a display device (e.g., TV) for playing. The set-top box can generate at least one record according to a status of advertisement being watched by users (for example, clicking to watch detailed content of the advertisement or to buy the advertised goods), and then transmit the record back to the advertising server unit. Then, the advertising server unit generates a bill according to the record for charging the advertiser.

### BACKGROUND OF INVENTION

1. Field of the Invention

The invention relates to an advertising system and method thereof, and more particularly to an advertising system and method thereof that broadcasts advertisements together with television signals via a set-top box, delivers these advertisements in ways beneficial for both the advertiser and the viewers, and calculates pricing for the advertisements based on a number of inputs that more accurately measure the effectiveness of the advertisement than the existing measurement systems on the market.

2. Description of the Prior Art

People constantly come into contact with a variety of advertisements—on billboards, in newspapers and magazines, on fliers, in radio and television programs, and on websites. Of all these, television is and especially popular media for advertisers due to its wide geographical coverage, ability to reach a wide range of audience, and the richness in presentation format via video and audio.

The cost for television advertisements is high. In order to make the best ad-buying decisions, businesses currently rely on a few metrics that give indirect indication, but no direct evidence, of the advertisements' effectiveness. Differentiating time slots based on what percentage of general households are watching TV at that particular time is one method used to determine the “prime time”. Simply buying ad placements in prime time, however, does not necessarily mean a higher percentage of the advertiser's targeted audience is reached, as the demographic mix of TV watchers change from hour to hour.

Another method frequently used in ad-buying decision is to analyze the demographics of viewing audience for a certain program. While more targeted to their intended audience, advertisers still have no way of knowing whether the audience watched the ads along with the program, and what their reactions were.

Perhaps the greatest uncertainty in TV-ad buying comes from the ubiquity of cable TV. Households with cable tend to watch even the free-on-air local channels through their cable services. While the content of the free-on-air programs tend to be identical whether one watched it via cable or terrestrial/satellite reception, the advertisement can be changed or localized by the cable company. In other words, when one buys ad placements with a free-on-air local station, the advertisement may not even show in the cable households.

The lack of transparency to the effectiveness of ad placements comes mainly form that fact that the current television advertisements are limited to one-way broadcasting without any feedbacks. If one can devise an advertising system that incorporates user feedback, advertisers will be able to make much more precise ad-buying decisions.

In addition to pricing of advertisement, advertisers can also benefit from a better method of TV ad delivery. Currently, TV audiences cannot alter the speed, content, format, or timing of advertisements they view. Nor can they provide any feedback to the advertisers. A better ad-delivery infrastructure that allows advertisers to more closely communicate with their targeted audience would not only increase the advertiser's return on investments, but also enhance the TV audience's ad-viewing experience.

### SUMMARY OF INVENTION

A primary objective of the invention is to propose an advertising system and method thereof, which may determine pricing for advertisements that better matches the ad's value to the advertisers, according to a number of relevant factors including but not limited to a subset of the following:

(a) The number of times customers have actually viewed the advertisements,

(b) broadcasting time,

(c) broadcasting length,

(d) broadcasting frequency,

(e) speed at which the advertisement is viewed, and

(f) may also affect the charging of the advertisement.

A further objective of the invention is to propose an advertising system and method thereof, which combines the advertisement with a television program for simultaneous broadcasting on televisions by the use of a set-top box, so as to allow audiences to view at least a portion of the advertisement when watching television programs (for example, headlines of an advertisement can scroll across the bottom of the screen). In addition, regardless of which channel the viewer is watching on television, advertisements broadcasted via the advertising system of the invention and method thereof can be consistently displayed on the screen of the television, thus optimizing the cost-effectiveness of the advertisements and preventing advertisements placed with free-on-air stations from being substituted by cable television operators.

In order to achieve the aforementioned objectives, the present invention discloses an advertising system comprises an advertising server unit and a set-top box. The advertising server unit is capable of receiving at least one advertisement from at least one external advertiser, and broadcasting at least part of the advertisement to outside in a pushing manner. The set-top box is capable of receiving TV signals from outside (e.g., from TV station or satellite TV) and the advertisement. This advertising server can then combine the advertisement with the TV signals, and transmit the combined signals to a display device (e.g., TV) for playing. The set-top box can generate at least one record regarding the status of the advertisement (for example, a record that the viewer has clicked on the headline to watch the entire ad; or, a record that the viewer has clicked through to purchase the advertised goods.), and then transmit the record back to the advertising server unit. Then, the advertising server unit generates a bill according to the record for charging the advertiser.

In a preferred embodiment, the advertising server unit further comprises:

a data analysis unit for receiving and analyzing the advertisement in order to generate shorter, condensed version of the advertisement;

a database for receiving both the shorter and the original versions of the advertisement from the data analysis unit for storage, as well as the record from the set-top box for storage;

an advertisement coding unit for receiving and coding the shorter advertisement from the data analysis unit into a format for broadcasting;

a billing unit for generating the bill according to the record in the database;

an extraction-data generating unit for receiving an extraction command from the set-top box, and sending the corresponding original advertisement stored in the database to the set-top box according to the extraction command; and

a scheduling-data generating unit for scheduling broadcasting times for at least one shorter advertisement or one original advertisement, and retrieving the shorter advertisement or the original advertisement from the database at scheduled times, before sending the shorter advertisement or the original advertisement to the advertisement coding unit for broadcasting.

In a preferred embodiment, the set-top box further comprises:

an advertisement decoding unit for decoding advertisements received via broadcasting;

an advertisement extraction unit for sending an extraction command to the advertising server unit according to an extraction signal, so as to extract at least one advertisement;

a database for storing advertisements from the advertisement decoding unit and the advertisement extraction unit;

a coding and joining unit for receiving the television signal, then combining the television signal with the advertisement into a video signal, and then sending out the video signal;

a primary control unit for receiving a control signal from the user, and generating at least one extraction signal according to the control signal, so as to allow the advertisement extraction unit to extract advertisements from the advertising server unit for broadcasting; in addition, the primary control unit generates the record for transmission to the advertising server unit according to a status of the extracted advertisements;

an ordering unit for receiving an ordering signal from the primary control unit, and generating an ordering command to advertisers according to the ordering signal, as well as generating an ordering record for transmission to the advertising server unit; wherein the ordering signal is generated via the primary control unit according to the control signal from the user;

an antenna for receiving broadcasting signals;

a frontal unit connected to the antenna for processing the received broadcasting signals into digital signals readable by computers; the advertisement decoding unit further comprises: a decoder connected to the frontal unit for decoding the digital signals into digital data, a data channel unit connected to the decoder for compiling the decoded digital data and storing the digital data into the database, and an MPEG-2 video compression module connected to the decoder for converting the decoded digital data, so that the decoded digital data is compatible with an MPEG-2 standard;

a primary control module connected to the database at least, further comprising: the advertisement extraction unit, the coding and joining unit, the primary control unit, and the ordering unit;

a demodulator connected to the primary control module and a television signal input, so as to receive and demodulate the television signal into video formats adequate for broadcasting;

a television output unit connected to the demodulator and the primary control module, for converting the television signal that has been combined with advertisements via the coding and joining unit into video formats adequate for broadcasting on display devices;

a network unit disposed in the primary control module for allowing the set-top box to have network connectivity;

a network interface for connecting to an external network of the Internet; wherein the set-top box sends the record and the command to the advertising server unit and the advertisers via the network unit, the network interface, and the Internet;

a coder connected to the primary control module for coding digital data transmitted from the primary control module; and

an MPEG-4 video compression module connected to the coder for converting the coded digital data, so that the coded digital data is compatible with an MPEG-4 standard.

In order to achieve the aforementioned objectives, the present invention further discloses an advertising method that may be implemented in an advertising server unit, comprising:

receiving an advertisement from an advertiser;

storing the advertisement in a database, and broadcasting at least a portion of the advertisement to at least a user;

according to a control signal from the user, retrieving the advertisement corresponding to the control signal from the database, and transmitting the advertisement to the user, subsequently generating a record of viewing; and

generating a bill according to at least the record of viewing so as to charge advertisers.

### BRIEF DESCRIPTION OF THE DRAWINGS

The structure and the technical means adopted by the present invention to achieve the above and other objects can be best understood by referring to the following detailed description of the preferred embodiments and the accompanying drawings; wherein,

FIG. 1 is a schematic view that shows interactions between an advertising system of the invention and other external devices;

FIG. 2 is a structural view that shows the application of the advertising system of the invention in a set-top box for televisions according to a preferred embodiment of the invention;

FIG. 3 is a schematic view that shows data flows between the advertising system of the invention indicated in FIG. 2 and other external devices;

FIG. 4 is a schematic view that shows internal structures and data flows of an advertising server unit of the invention indicated in FIG. 3;

FIG. 5 is a schematic view that shows internal structures and data flows of a set-top box of the invention indicated in FIG. 3;

FIG. 6 is a schematic view that shows another preferred embodiment for the set-top box of the invention, in which functions such as processing of television signals and network connection are disclosed;

FIG. 7 is a first schematic view that shows displaying of video on a display device via the advertising system of the invention and method thereof;

FIG. 8 is a second schematic view that shows displaying of video on a display device via the advertising system of the invention and method thereof;

FIG. 9 is a third schematic view that shows displaying of video on a display device via the advertising system of the invention and method thereof; and

FIG. 10 is a fourth schematic view that shows displaying of video on a display device via the advertising system of the invention and method thereof.

### DETAILED DESCRIPTION OF PREFERRED EMBODIMENTS

The structure and the technical means adopted by the invention to achieve the aforesaid objectives can be best understood by referring to the following detailed description of the preferred embodiments and the accompanying drawings.

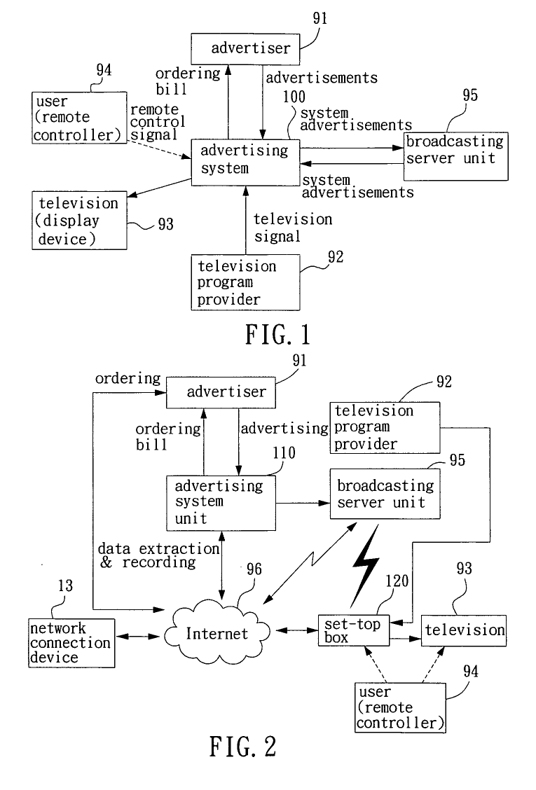

FIG. 1 is a schematic view that shows interactions between an advertising system of the invention and other external devices.

An advertising system 100 of the invention may receive advertisements to be broadcasted from one or more advertisers 91. The advertisements are firstly processed into system advertisements via the advertising system 100, and then the system advertisements are transmitted to a broadcasting server unit 95 so as to be pushed via broadcasting. The broadcasting server unit 95 mainly pushes the system advertisements to a plurality of widely distributed terminal devices of the advertising system 100 of the invention; the terminal devices may be set up by one same operator of the advertising system 100 of the invention, or set up by other operators of wireless or cable broadcasting base stations. For example, the terminal devices may be but not limited to: television broadcasting base stations, digital video base (DVB) stations, digital audio base (DAB) stations, satellite TV base stations, cable TV base stations, GSM base stations, GPRS base stations, CDMA base stations, ADSL base stations, WiFi base stations, or WiMAX base stations. On the other hand, the advertising system 100 may receive television signals provided by television program providers 92 at the terminal devices. In a preferred embodiment of the invention, a television program provider 92 is preferably a cable TV operator, but may also be a wireless TV operator, a satellite TV operator, or a DVB operator. The advertising system 100 combines the aforesaid system advertisements with the television signals before transmitting the combined system advertisements and the television signals to a display device (such as a television 93) for broadcasting. In a preferred embodiment of the invention, the display device is preferably a television 93, but may also be any other electronic devices having display screens. For example, the display devices may be but not limited to: monitors for computers, laptop computers, personal digital assistants (PDAs), smart phones, and electronic stock managers. After users (i.e. people who are watching the television) have viewed the system advertisements played on the display device (the television 93), they may transmit a remote control signal to the terminal device of the advertising system 100 via operating a remote controller 94 or other input devices (such as a keyboard or a mouse), so as to (but not limited to): view details of the advertisements or initiate commands for ordering and purchasing products or services. On the one hand, the advertising system 100 transmits the ordering command to an advertiser 91 so as to carry out related transactions, and generates a record according to viewing of the advertisements by the users (such as a number of times the system advertisement is played, a number of times the details of the advertisements are viewed, or a number of times the products or services are ordered and purchased). Subsequently, the advertising system 100 determines how much to charge for the advertisements according to the record, and generates a bill to charge related payments from the advertiser 91.

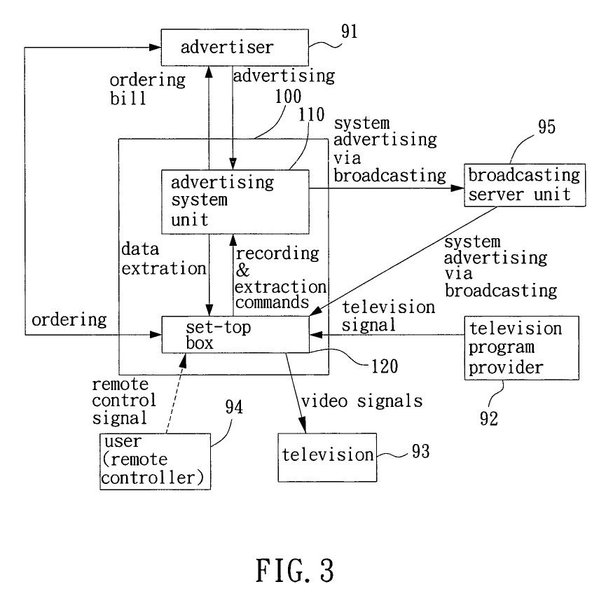

Referring to FIGS. 2 and 3; wherein FIG. 2 is a structural view that shows the application of the advertising system of the invention to a set-top box for televisions according to a preferred embodiment of the invention, and FIG. 3 is a schematic view that shows data flows between the advertising system of the invention shown in FIG. 2 and other external devices.

In the preferred embodiment shown in FIGS. 2 and 3, the advertising system 100 comprises an advertising server unit 110 and at least a set-top box 120 (i.e. the terminal device) distributed at each user's place. The advertising server unit 110 receives advertisements to be broadcasted from the advertiser 91, and then processes the advertisements into system advertisements adequate for broadcasting, and transmits the system advertisements to the broadcasting server unit 95. The broadcasting server unit 95 may push the system advertisements to a plurality of terminal devices located at various locations via cable or wireless broadcasting; the terminal devices may be the set-top box 120 shown in FIGS. 2 and 3, or a network connection device 13 indicated in FIG. 2. In this preferred embodiment, a broadcasted system advertisement includes at least a portion of the advertisement, such as the inclusion of headlines or logos of the advertisement only. The set-top box 120 not only receives the aforesaid system advertisements, but also television signals provided by external television program providers 92; subsequently combines the system advertisements together with the television signals in order to generate a joint video signal, before sending the video signal for playing on the television 93 (the display device). Because the system advertisements are combined with the television signals and transmitted to the television 93 along with the television signals, and shown on the television 93 along with television programs in a separate window or scrolled as banner lines, users will always see the system advertisements as long as they are watching television. Moreover, the broadcasting of the system advertisements will not be affected by switching channels on the part of the users, or be substituted with other advertisements by the cable television operators. In another preferred embodiment of the invention, the set-top box 120 may also provide a function for switching off the advertisements, so as to allow the users to decide whether to remove the system advertisements from the video signal or not; in other words, the users may decide whether to simultaneously display the system advertisements and television programs on television 93 or not. If a user becomes interested in a system advertisement, he may select the system advertisement via the remote control signals from the remote controller 94 or other input devices. Subsequently, the set-top box 120 generates an extraction command that corresponds to the selected system advertisement, and then transmits the extraction command to the advertising server unit 110 via the Internet 96 or other network interfaces. Consequently, the advertising server unit 110 transmits detailed contents of the selected system advertisement that corresponds to the extraction command back to the set-top box 120 via the Internet 96 or other network interfaces, and then plays the detailed contents of the selected system advertisement on the television 93 for the users to watch. The set-top box 120 generates a record of viewing that corresponds to the selected system advertisement, and sends the record to the advertising server unit 110 in order to generate a bill for charging the advertiser 91. In yet another preferred embodiment of the invention, the record of viewing may also be generated from the advertising server unit 110, and the set-top box 120 is only responsible for transmitting the extraction command. In addition, if a user intends to purchase an advertised product, he may execute a function of ordering the advertised product via the remote control signals from the remote controller 94 or other input devices. The set-top box 120 generates an ordering command that corresponds to the ordered advertisement, and then transmits the ordering command to the advertiser 91 for further transactions via the Internet 96 or other network interfaces. The set-top box 120 also generates an ordering record that corresponds to the ordered advertisement, and then transmits the ordering record to the advertising server unit 110 in order to generate a bill for charging the advertiser 91.

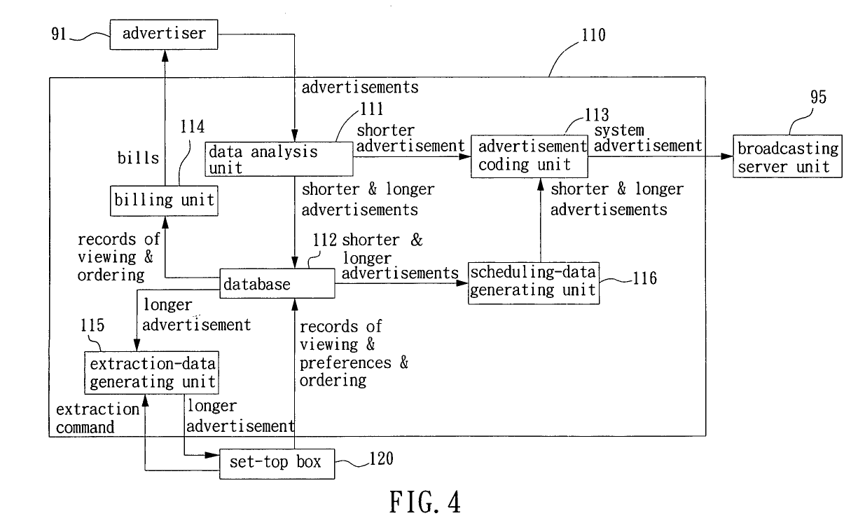

Referring to FIG. 4, which is a schematic view that shows internal structures and data flows of an advertising server unit 110 of the invention indicated in FIG. 3. In this preferred embodiment, the advertising server unit 110 further comprises: a data analysis unit 111, a database 112, an advertisement coding unit 113, a billing unit 114, an extraction-data generating unit 115, and a scheduling-data generating unit 116. The units 111-116 of the advertising server unit 110 may be implemented as a combination of hardware and software, or as software only.

The data analysis unit 111 is used to receive and analyze an advertisement from the advertiser 91, and then correspondingly generate a shorter advertisement and a longer advertisement. The shorter advertisement may be at least a portion of the received advertisement, such as headlines, brand names, logos, or banners of the received advertisement, which are the aforesaid system advertisement. On the other hand, the longer advertisement is the detailed contents of the received advertisement, which may include words, pictures, animation, and fields or other similar features for users to put orders. The database 112 may be a hard disk or any other storage media of prior arts, which may receive the shorter advertisement and the longer advertisement from the data analysis unit 111 for storage, or various records from the set-top box 120 for storage. The various records include at least one of the following: a record of viewing of advertisements (for example, a number of times the shorter advertisement and the longer advertisement are viewed), a record of user preferences (for instance, users may decide their preferred types of advertisements), and an ordering record of users. The advertisement coding unit 113 receives the shorter advertisement from the data analysis unit 111, and codes the shorter advertisement into the system advertisement adequate for broadcasting, before transmitting the system advertisement to an external broadcasting server unit 95. The billing unit 114 is used to generate bills according to the various records in the database 112 and transmit the bills to the external advertiser 91 for charging payments. The bills may not only be generated according to the various records, but also according to the scheduled broadcasting time, broadcasting length, and broadcasting frequency of the advertisement. The extraction-data generating unit 115 receives an extraction command from the set-top box 120, and transmits a corresponding longer advertisement stored in the database 112 to the set-top box 120 for broadcasting according to the extraction command. The scheduling-data generating unit 116 schedules the broadcasting time of at least one shorter advertisement or one longer advertisement, and retrieves the shorter advertisement or the longer advertisement from the database 112 at scheduled times, then transmits the shorter advertisement or the longer advertisement to the advertisement coding unit 113 for pushing. Therefore, advertisers may decide (or purchase) a specific period of time for broadcasting their own advertisements. For example, the advertisers may broadcast only the shorter advertisements at times other than the prime time, and broadcast the longer advertisements when users selected the advertisements. However, the longer advertisements may be directly pushed to all of the set-top boxes 120 for broadcasting via the broadcasting server unit 95 at a prime time.

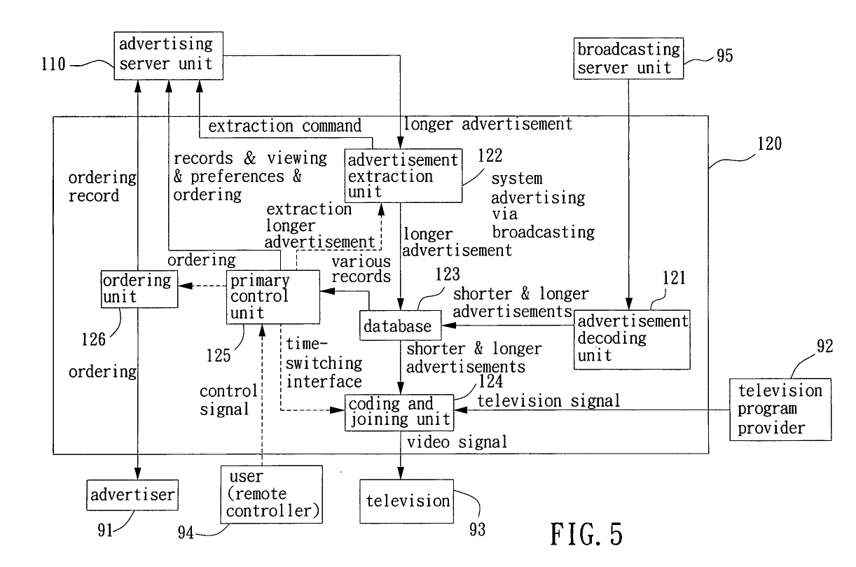

Referring to FIG. 5, which is a schematic view that shows internal structures and data flows of a set-top box 120 of the invention indicated in FIG. 3. In this preferred embodiment, the set-top box 120 further comprises: an advertisement decoding unit 121, an advertisement extraction unit 122, a database 123, a coding and joining unit 124, a primary control unit 125, and an ordering unit 126.

The advertisement decoding unit 121 receives the system advertisements broadcasted from the broadcasting server unit 95, and then decodes the system advertisements into data signals that may be processed by computers (including the shorter advertisements and the longer advertisements). The advertisement extraction unit 122 may transmit an extraction command to the advertising server unit 110 according to an extraction signal, so as to extract at least one longer advertisement. The database 123 is used to store the shorter advertisements and the longer advertisements from the advertisement decoding unit 121 and the advertisement extraction unit 122. The coding and joining unit 124 may receive television signals from an external television program provider 92, and combines the received television signals together with the shorter advertisements or the longer advertisements from the database 123 to give rise to a video signal, then transmits the video signal to an external television 93 or an external display device. The primary control unit 125 may receive a control signal generated from a remote controller 94 operated by a user, and generate at least the extraction signal according to the control signal, so as to make the advertisement extraction unit 122 extract and broadcast the longer advertisements from the advertising server unit 110. The primary control unit 125 also generates a record that corresponds to a status indicating the extraction of advertisements (such as the record of viewing, or record of preferences) for transmission to the advertising server unit 110. The ordering unit 126 is used to receive an ordering signal from the primary control unit 125, and generate an ordering command according to the ordering signal before transmitting the ordering command to the advertiser 91, as well as generating and transmitting an ordering record to the advertising server unit 110. The ordering signal is generated from the primary control unit 125 according to the control signals from the remote controller 94 operated by the user.

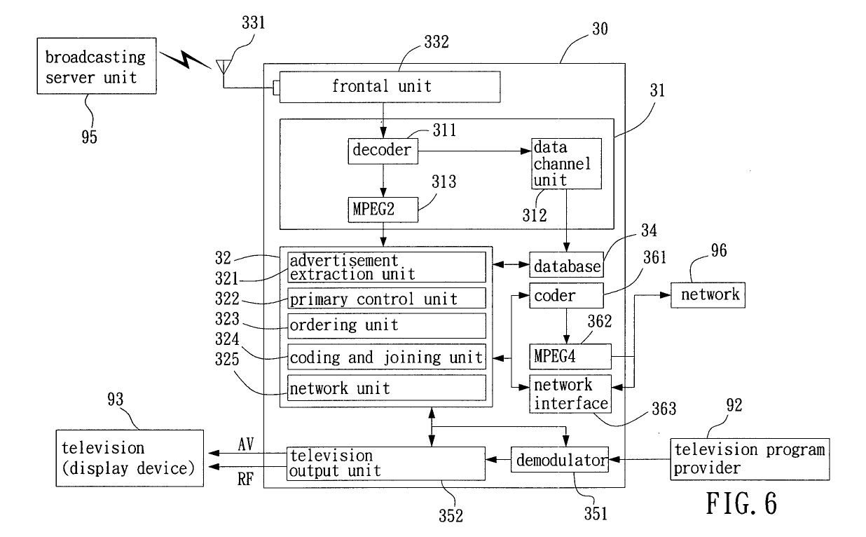

The disclosed components and structures of the set-top box 120 shown in FIG. 5 are related to the advertising system and method thereof of the invention only, the components and structures related to the processing of television signals or network connection are not disclosed. Referring to FIG. 6, which is a schematic view that shows a preferred embodiment for a set-top box 30 of the invention, in which components and structures for processing television signals and network connection are disclosed.

As shown in FIG. 6, the set-top box 30 of the invention comprises; an advertisement decoding unit 31, a control module 32, an antenna 331, a frontal unit 332, a database 34, a demodulator 351, a television output unit 352, a coder 361, an MPEG-4 video compression module 362, and a network interface 363.

The antenna 331 is used to receive broadcasting signals. The frontal unit 332 is connected to the antenna 331 and used for processing the received broadcasting signals into digital signals readable by computers. In this preferred embodiment, the frontal unit 332 may include components like regulators of DVB-T/H, DAB, DMB; as well as processors of media data streams. These components are of prior arts and will not be further described here.

The advertisement decoding unit 31 further comprises: a decoder 311 connected to the frontal unit 332 for decoding the digital signals into digital data, a data channel unit 312 connected to the decoder 311 for compiling and storing the decoded digital data into the database 34, and an MPEG-2 video compression module 313 connected to the decoder 311 for converting the decoded digital data, so that the decoded digital data is compatible with an MPEG-2 standard.

The primary control module 32 is connected to the advertisement decoding unit 31, the database 34, the demodulator 351, the television output unit 352, the coder 361, and the network interface 363. The primary control module 32 further includes: an advertisement extraction unit 321 identical to the one shown in FIG. 5, a primary control unit 322, an ordering unit 323, a coding and joining unit 324, and an additional network unit 325. The network unit 325 included in the primary control module 32 allows the set-top box 30 to have network connectivity.

The demodulator 351 is connected to the primary control module 32 and a television signal input (i.e. the television program provider 92), so as to receive and demodulate the television signal into a video format adequate for broadcasting. The television output unit 352 is connected to the demodulator 351, the primary control module 32, and an external television 93 (the display device), and may convert the television signal that has been combined with advertisements by the coding and joining unit 324 into a video format playable on the television 93 (the display device). The network interface 363 provides an interface for connecting to an external network of the Internet 96, so that the set-top box 30 may transmit the records and the commands to the advertising server unit 110 and the advertiser 91 via the network unit 325, the network interface 363, and the Internet 96. The coder 361 is connected to the primary control module 32 and the MPEG-4 video compression module 362, so as to code the digital data transmitted from the primary control module 32. The MPEG-4 video compression module 362 is connected to the coder 361 for converting the coded digital data, so that the coded digital data is compatible with an MPEG-4 standard. As a result, the set-top box 30 of the invention may firstly combine a television signal from the television program provider 92 with a system advertisement from the broadcasting server unit 95, and then converts a resulted video signal into the MPEG-4 format before transmitting the video signal via the Internet 96, so that an external network connection device 13 (only shown in FIG. 2) may connect to the set-top box 30 and receive television programs and advertisements via the Internet 96.

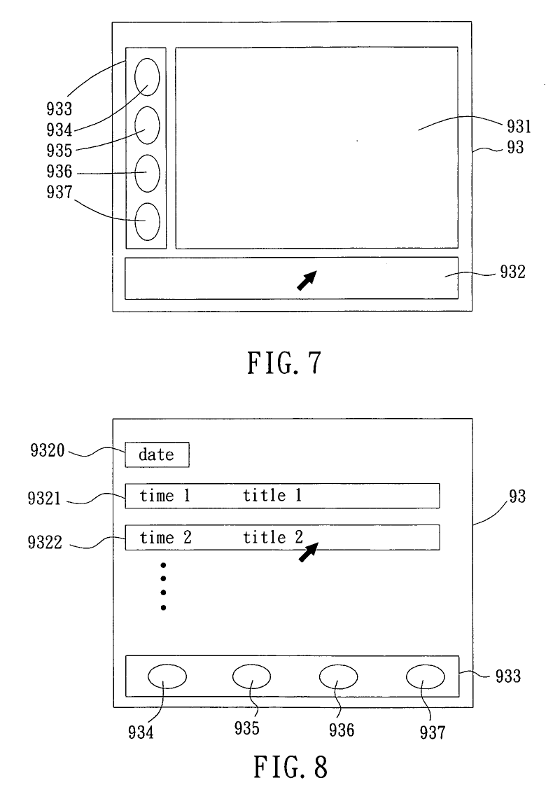

Referring to FIGS. 7-10, which are schematic views that show video being displayed on a display device via the advertising system of the invention and method thereof.

As indicated in FIG. 7, in the advertising system and method thereof according to a preferred embodiment of the invention, when the set-top box receives a television signal and a system advertisement, the set-top box combines the television signal and the system advertisement into a video signal, and then transmits the video signal to the television 93 (or other display devices) for broadcasting. In the mean time, a screen of the television 93 displays: a main window 931, an advertising window 932, and a shortcut window 933. The main window 931 primarily plays television programs, thus the main window 931 occupies most of the screen of the television 93. The advertising window 932 is located at a lateral side on the screen of the television 93 (such as a lower lateral side), and displays system advertisements via scrolling (i.e. the advertisements are scrolled one by one). For example, several headlines or logos of the advertisements may be displayed in turns. The shortcut window 933 is located at another lateral side (such as the left hand side) on the screen of the television 93, which may include several fields of shortcut 934, 935, 936, and 937. Each of the fields of shortcut 934, 935, 936, and 937 corresponds to a special function, respectively. For instance, a function of allowing users to go to personal advertising pages provided by the advertising system, a function of allowing users to go to ordering pages, or a function of allowing users to go to pages for setting up users' preferences. By operating the remote controller or other input devices, the user may select any system advertisements shown in the advertising window 932, or select any fields of shortcut 934, 935, 936, and 937 shown in the shortcut window 933, or switch between different television channels shown in the main window 931. Regardless of which channel the user is watching, only the images displayed in the main window 931 is changed, and the images displayed in the advertising window 932 and the shortcut window 933 are not affected. In another preferred embodiment of the invention, the set-top box may also provide a function of switching off the advertisements, so as to allow the users to decide whether to remove the system advertisements from the video signal or not; in other words, the users may decide whether to simultaneously display the system advertisements and television programs on the television 93 or not, or simply watch television programs without the system advertisements.

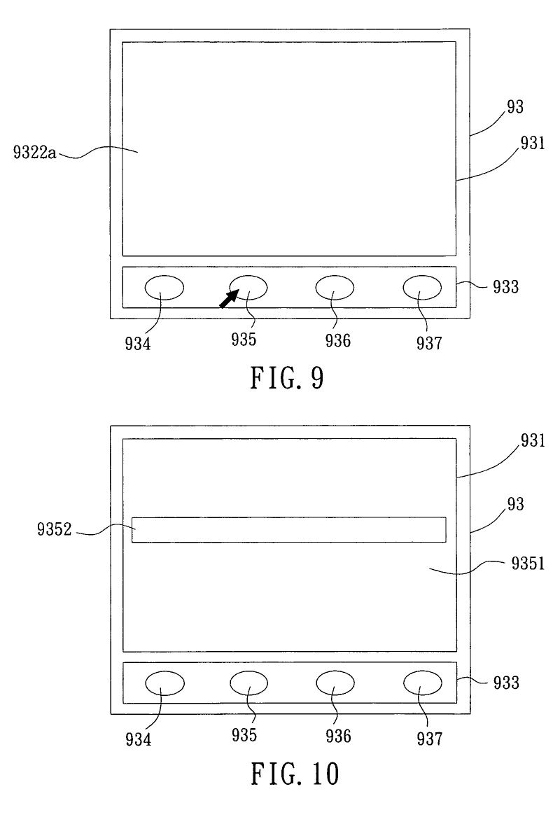

As shown in FIG. 8, if the user selects any of the system advertisements from the advertising window 932, a listing of advertisements is immediately shown on the main window 931, followed by displaying a date 9320, as well as times and titles of advertisements 9321 and 9322 on screen; the shortcut window 933 is also moved to a lower part of the screen to prevent the shortcut window 933 from obstructing the view. If the user is interested in a particular advertisement (for example, the second advertisement 9322), he may select the advertisement 9322 to enter a status shown in FIG. 9. As indicated in FIG. 9, detailed contents the selected advertisement 9322a is extracted from the advertising server unit and shown in the main window 931 of the television 93, while the set-top box generates and transmits a record of viewing to the advertising server unit. If the user intends to purchase a product related to the advertisement, he may select a field of shortcut 935 to display an ordering page shown in FIG. 10. It may be seen in FIG. 10 that an ordering option 9351 is shown in the main window 931, which includes specifications or descriptions of pricing for the product to be ordered, and a field for paying 9352 that allows the user to pay for the product. For example, the field for paying 9352 may be but not limited to: for filling out credit card information and credit card authorization, for ATM payment transfer, or for online transactions.

Although a preferred embodiment of the invention has been described for purposes of illustration, it is understood that various changes and modifications to the described embodiment can be carried out without departing from the scope and the spirit of the invention as disclosed in the appended claims.

What is claimed is:

1. An advertising system, which receives at least one advertisement from at least one external advertisers then broadcasts the advertisement to at least one user, and charges advertisers basing on viewing of advertisements by users; the advertising system comprising:
an advertising server unit for receiving the advertisement from the advertiser, and then sending out at least a portion of the advertisement via broadcasting; and
a set-top box for receiving a television signal from an external source and the advertisement, then combining the advertisement together with the television signal, before transmitting the advertisement together with the television signal to a display device for broadcasting, the set-top box subsequently generating at least a record according to viewing of advertisements by users, and then sending the record back to the advertising server unit;
wherein the advertising server unit generates a bill according to the record for charging advertisers.

2. The advertising system of claim 1, wherein the advertising server unit further comprises:
a data analysis unit for receiving and analyzing the advertisement in order to generate a corresponding shorter advertisement and a corresponding longer advertisement;
a database for receiving the shorter advertisement and the longer advertisement from the data analysis unit for storage, as well as the record from the set-top box for storage;
an advertisement coding unit for receiving and coding the shorter advertisement from the data analysis unit into a format for broadcasting; and
a billing unit for generating the bill according to the record in the database.

3. The advertising system of claim 2, wherein the advertising server unit further comprises:
an extraction-data generating unit for receiving an extraction command from the set-top box, and sending a corresponding longer advertisement stored in the database to the set-top box according to the extraction command; and
a scheduling-data generating unit for scheduling broadcasting times for at least one shorter advertisement or one longer advertisement, and retrieving the shorter advertisement or the longer advertisement from the database at scheduled times, before sending the shorter advertisement or the longer advertisement to the advertisement coding unit for broadcasting.

4. The advertising system of claim 3, wherein the record includes at least one of the following: records of viewing of advertisements, records of user preferences, and records of users' orders; in addition, the bill may not only be generated according to the record via the aforesaid method, but also according to scheduled broadcasting time, broadcasting length, and broadcasting frequency of the advertisement.

5. The advertising system of claim 1, wherein the set-top box further comprises:
an advertisement decoding unit for decoding advertisements received via broadcasting;
an advertisement extraction unit for sending an extraction command to the advertising server unit according to an extraction signal, so as to extract at least one advertisement;
a database for storing advertisements from the advertisement decoding unit and the advertisement extraction unit;
a coding and joining unit for receiving the television signal, then combining the television signal with the advertisement into a video signal, and then sending out the video signal;
a primary control unit for receiving a control signal from the user, and generating at least one extraction signal according to the control signal, so as to allow the advertisement extraction unit to extract advertisements from the advertising server unit for broadcasting; in addition, the primary control unit generates the record for transmission to the advertising server unit according to a status of the extracted advertisements; and
an ordering unit for receiving an ordering signal from the primary control unit, and generating an ordering command to advertisers according to the ordering signal, as well as generating an ordering record for transmission to the advertising server unit;
wherein the ordering signal is generated via the primary control unit according to the control signal from the user.

6. The advertising system of claim 5, wherein the set-top box further comprises:
an antenna for receiving broadcasting signals;
a frontal unit connected to the antenna for processing the received broadcasting signals into digital signals readable by computers;
the advertisement decoding unit further comprises: a decoder connected to the frontal unit for decoding the digital signals into digital data, a data channel unit connected to the decoder for compiling the decoded digital data and storing the digital data into the database, and an MPEG-2 video compression module connected to the decoder for converting the decoded digital data, so that the decoded digital data is compatible with an MPEG-2 standard;
a primary control module connected to the database at least, further comprising: the advertisement extraction unit, the coding and joining unit, the primary control unit, and the ordering unit;
a demodulator connected to the primary control module and a television signal input, so as to receive and demodulate the television signal into video formats adequate for broadcasting;
a television output unit connected to the demodulator and the primary control module, for converting the television signal that has been combined with advertisements via the coding and joining unit into video formats adequate for broadcasting on display devices;
a network unit disposed in the primary control module for allowing the set-top box to have network connectivity;
a network interface for connecting to an external network of the Internet; wherein the set-top box sends the record and the command to the advertising server unit and the advertisers via the network unit, the network interface, and the Internet;
a coder connected to the primary control module for coding digital data transmitted from the primary control module; and
an MPEG-4 video compression module connected to the coder for converting the coded digital data, so that the coded digital data is compatible with an MPEG-4 standard.

7. An advertising system, comprising a set-top box for receiving a television signal and an advertisement from an advertising server unit, and then combining the advertisement together with the television signal, before sending the combined advertisement and the television signal for broadcasting; the set-top box comprising:
an advertisement decoding unit for decoding received advertisements;
an advertisement extraction unit for sending an extraction command to the advertising server unit according to an extraction signal, so as to extract at least one advertisement;
a database for storing advertisements from the advertisement decoding unit and the advertisement extraction unit;
a coding and joining unit for receiving the television signal, then combining the television signal with the advertisement into a video signal, subsequently sending out the video signal; and
a primary control unit for receiving an external control signal, and generating at least one extraction signal according to the control signal, so as to allow the advertisement extraction unit to extract advertisements from the advertising server unit for broadcasting; in addition, the primary control unit generates at least one record for transmission to the advertising server unit according to a status of the extracted advertisements.

8. The advertising system of claim 7, wherein the set-top box further comprises:
an ordering unit for receiving an ordering signal from the primary control unit, and generating an ordering command to an external advertiser according to the ordering signal, as well as generating an ordering record for transmission to the advertising server unit; wherein the ordering signal is generated via the primary control unit according to the external control signal;
an antenna for receiving a broadcasting signal including the advertisement;
a frontal unit connected to the antenna for processing the received broadcasting signal into a digital signal readable by computers;
the advertisement decoding unit further comprises: a decoder connected to the frontal unit for decoding the digital signal into a digital data, a data channel unit connected to the decoder for compiling the decoded digital data and storing the digital data into the database, and an MPEG-2 video compression module connected to the decoder for converting the decoded digital data, so that the decoded digital data is compatible with an MPEG-2 standard;
a primary control module connected to the database at least, further comprising: the advertisement extraction unit, the coding and joining unit, the primary control unit, and the ordering unit;
a demodulator connected to the primary control module and a television signal input, so as to receive and demodulate the television signal into video formats adequate for broadcasting;
a television output unit connected to the demodulator and the primary control module, for converting the television signal that has been combined with advertisements via the coding and joining unit into video formats adequate for broadcasting on display devices;

9. The advertising system of claim 8, wherein the set-top box further comprises:
a network unit disposed in the primary control module for allowing the set-top box to have network connectivity;
a network interface for connecting to an external network of the Internet; wherein the set-top box sends the record and the command to the advertising server unit and the advertisers via the network unit, the network interface, and the Internet;
a coder connected to the primary control module for coding digital data transmitted from the primary control module; and
an MPEG-4 video compression module connected to the coder for converting the coded digital data, so that the coded digital data is compatible with an MPEG-4 standard.

10. An advertising method that may be implemented in an advertising server unit, comprising:
receiving an advertisement from an advertiser;
storing the advertisement in a database, and broadcasting at least a portion of the advertisement to at least a user;
according to a control signal from the user, retrieving the advertisement corresponding to the control signal from the database, and transmitting the advertisement to the user, subsequently generating a record of viewing; and
generating a bill according to at least the record of viewing so as to charge advertisers.

11. The advertising method of claim 10, wherein the user receives the broadcasted advertisement, generates the control signal, and generates the record of viewing via a set-top box.

12. The advertising method of claim 11, further comprising following steps applicable in the set-top box:
receiving an external television signal and advertisements from the advertising server unit;
combining the advertisement together with the television signal for broadcasting on a display device, simultaneously displaying at least a program window and an advertising window on the display device, and displaying at least a portion of the advertisement in the advertising window;
receiving a control signal from the user for selecting advertisements in the advertising window, then generating and transmitting a corresponding extraction command to the advertising server unit, so as to retrieve all contents of the selected advertisement from the database of the advertising server unit for displaying on the program window; consequently generating a record of viewing that corresponds to the selected advertisement.

13. The advertising method of claim 12, wherein the set-top box may further carry out following steps:
accepting another control signal from the user when all of the contents of the selected advertisement are displayed in the program window, and generating an ordering command for transmission to the advertisers according to the other control signal, as well as generating an ordering record for transmission to the advertising server unit;
wherein the method for generating the aforesaid bill not only includes generating the bill according to the record of viewing, but also according to the ordering record, as well as the scheduled broadcasting time, length, and frequency of the advertisement.

14. The advertising method of claim 11, wherein the set-top box comprises:
an advertisement decoding unit for decoding received advertisements;
an advertisement extraction unit for sending an extraction command to the advertising server unit according to an extraction signal, so as to extract at least one advertisement;
a database for storing advertisements from the advertisement decoding unit and the advertisement extraction unit;
a coding and joining unit for receiving the television signal, then combining the television signal with the advertisement into a video signal, subsequently sending out the video signal; and
a primary control unit for receiving an external control signal, and generating at least one extraction signal according to the control signal, so as to allow the advertisement extraction unit to extract advertisements from the advertising server unit for broadcasting; in addition, the primary control unit generates at least one record for transmission to the advertising server unit according to a status of the extracted advertisements.

15. The advertising method of claim 14, wherein the set-top box further comprises:
an ordering unit for receiving an ordering signal from the primary control unit, and generating an ordering command to an external advertiser according to the ordering signal, as well as generating an ordering record for transmission to the advertising server unit; wherein the ordering signal is generated via the primary control unit according to the external control signal;
an antenna for receiving a broadcasting signal including the advertisement;
a frontal unit connected to the antenna for processing the received broadcasting signal into a digital signal readable by computers;
the advertisement decoding unit further comprises: a decoder connected to the frontal unit for decoding the digital signal into a digital data, a data channel unit connected to the decoder for compiling the decoded digital data and storing the digital data into the database, and an MPEG-2 video compression module connected to the decoder for converting the decoded digital data, so that the decoded digital data is compatible with an MPEG-2 standard;
a primary control module connected to the database at least, further comprising: the advertisement extraction unit, the coding and joining unit, the primary control unit, and the ordering unit;
a demodulator connected to the primary control module and a television signal input, so as to receive and demodulate the television signal into video formats adequate for broadcasting;
a television output unit connected to the demodulator and the primary control module, for converting the television signal that has been combined with advertisements via the coding and joining unit into video formats adequate for broadcasting on display devices;

16. The advertising method of claim 15, wherein the set-top box further comprises:
a network unit disposed in the primary control module for allowing the set-top box to have network connectivity;
a network interface for connecting to an external network of the Internet; wherein the set-top box sends the record and the command to the advertising server unit and the advertisers via the network unit, the network interface, and the Internet;
a coder connected to the primary control module for coding digital data transmitted from the primary control module; and
an MPEG-4 video compression module connected to the coder for converting the coded digital data, so that the coded digital data is compatible with an MPEG-4 standard.

17. The advertising method of claim 11, wherein the advertising server unit further comprises:
a data analysis unit for receiving and analyzing the advertisement in order to generate a corresponding shorter advertisement and a corresponding longer advertisement;
a database for receiving the shorter advertisement and the longer advertisement from the data analysis unit for storage, as well as the record from the set-top box for storage;
an advertisement coding unit for receiving and coding the shorter advertisement from the data analysis unit into a format for broadcasting; and
a billing unit for generating the bill according to the record in the database.

18. The advertising method of claim 17, wherein the advertising server unit further comprises:
an extraction-data generating unit for receiving an extraction command from the set-top box, and sending a corresponding longer advertisement stored in the database to the set-top box according to the extraction command; and
a scheduling-data generating unit for scheduling broadcasting times for at least one shorter advertisement or one longer advertisement, and retrieving the shorter advertisement or the longer advertisement from the database at scheduled times, before sending the shorter advertisement or the longer advertisement to the advertisement coding unit for broadcasting.
